(19) United States
(12) Patent Application Publication
(10) Pub. No.: US 2012/0205938 A1
(43) Pub. Date: Aug. 16, 2012

(54) SUN VISOR

(75) Inventor: Robert Spahl, Koeln (DE)

(73) Assignee: FORD GLOBAL TECHNOLOGIES, LLC, Dearborn, MI (US)

(21) Appl. No.: 13/366,688

(22) Filed: Feb. 6, 2012

(30) Foreign Application Priority Data
Feb. 14, 2011 (DE) 102011004067.6

(51) Int. Cl. B60J 3/04; B60J 3/02

(52) U.S. Cl. 296/97.2; 296/97.1; 296/97.5

(57) ABSTRACT

A sun visor (3), in particular for a motor vehicle, which is configured so as to be foldable between a non-use position and a use position via a folding joint (4), wherein the sun visor is configured in such a manner that it is transparent in the non-use position (A) and is opaque in the use position (B).

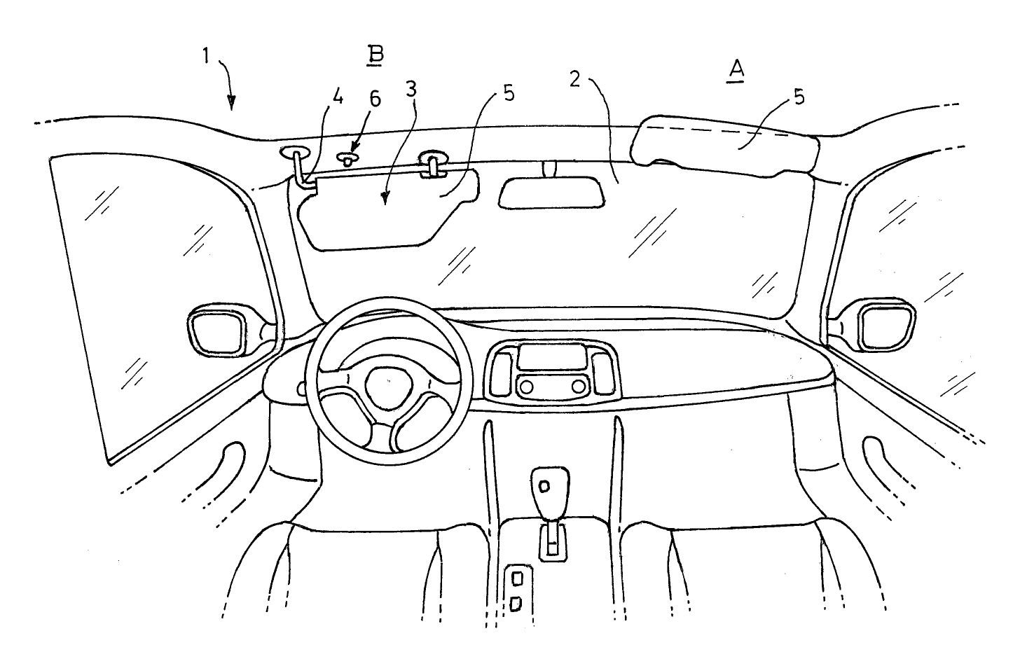

### FIELD OF THE INVENTION

The present invention generally relates to a sun visor, in particular for a motor vehicle, which is configured so as to be foldable between a non-use position and a use position via a folding joint.

### BACKGROUND OF THE INVENTION

Sun visors of this type serve as a sun shield or in general as a glare shield in motor vehicles and are typically configured so as to be foldable between a use position and a non-use position, for which purpose the sun visors are generally arranged above the windshield in the interior of the vehicles. The sun visors can generally also be pivoted away toward the side in order to prevent lateral glare.

JP 2009029245A discloses a sun visor for motor vehicles, in which the actual visor consists of a type of liquid crystal display (LCD) which, in the swung-down use position in front of the windshield, can be actively shaded in regions with regard to isolation which can be detected by means of a sensor. The visor is switched off in a lateral position and is therefore opaque (paragraphs [0025]-[0030]).

What are referred to as panorama roofs are integrated into modern vehicles, in particular passenger vehicles, the panorama roofs forming large windows in the roof of the vehicle, the windows frequently reaching as far as the windshield in the region of the driver.

When the sun visors are in the upwardly swung non-use position, they may interfere with the optics and the sensation of space, since they interfere with the free sight through the panorama window. The same applies to convertibles (in the open state).

Therefore, as before, a sun visor is required which satisfactorily carries out the function thereof in the use position and otherwise, in the non-use position, interferes as little as possible or is inconspicuous.

### SUMMARY OF THE INVENTION

According to one aspect of the present invention, a sun visor for a motor vehicle is provided. The sun visor is configured so as to be foldable between a non-use position and a use position via a folding joint. The sun visor is configured to be transparent in the non-use position and is opaque in the use position.

According to another aspect of the present invention, a sun visor for a motor vehicle is provided. The sun visor is foldable between a non-use position and a use position via a folding joint. The sun visor comprises a screening region configured to be substantially transparent in a non-use position, and substantially opaque in a use position.

These and other aspects, objects, and features of the present invention will be understood and appreciated by those skilled in the art upon studying the following specification, claims, and appended drawings.

### BRIEF DESCRIPTION OF THE DRAWINGS

In the drawing:

The FIGURE is a front perspective view of the vehicle interior illustrating sun visors, according to one embodiment.

### DETAILED DESCRIPTION OF THE PREFERRED EMBODIMENTS

Further details, features and advantages of the invention emerge from the description below of an exemplary embodiment with reference to the single drawing, in which a view is perspectively shown from a vehicle interior looking toward the windshield 2 of a passenger vehicle 1.

Referring to the FIGURE, the sun visor 3 can be seen at the upper edge of the windshield 2, the sun visor being configured so as to be foldable 4 between a non-use position A (on the right) and a use position B (on the left) via a folding joint. The sun visor 3 may pivot or fold about a rod as the folding joint. The non-use position is the position in which the sun visor 3 is not used to shield sunlight. This may include the generally horizontal position shown on the right side. The use position is the position in which the sun visor 3 may shield sunlight. This may include the generally vertical position shown on the left side above the steering wheel.

The sun visor 3 is configured in such a manner that it is opaque in the use position and transparent in the non-use position. In one embodiment, the sun visor 3 is configured such that it is darkened or substantially opaque in the use position and substantially transparent in the non-use position. In particular, the screening region 5 of the sun visor is opaque or substantially opaque in the use position and transparent or substantially transparent in the non-use position. The sun visor 3 may include a frame, and the screening region may essentially cover the entire surface of the sun visor 3 apart from the frame.

For this purpose, according to one embodiment, the screening region 5 of the sun visor is composed of electrochromic material, the transparency of which can be switched as required and which is appropriately activated.

A push switch 6 is provided on the roof lining above the sun visor 3, and therefore the visor 3 or the screening region 5 thereof presses against the switch 6 and, in the non-use position, is switched off or switched over to transparency of the electrochromic material.

By contrast, in the use position B, the screening region 5 is therefore always switched to opacity.

Owing to the fact that the sun visor is configured in such a manner that it is transparent in the non-use position and is opaque in the use position, it is inconspicuous and does not interfere in the non-use position.

However, this does not rule out the sun visor also not being opaque in the non-use position. This may be expedient if the sun visor is intended to act upward as a sun shield. In this case, a suitable switching mechanism may be provided, the switching mechanism switching over the sun visor between transparent and opaque in the non-use position.

This can be achieved in a simple manner by a switch in the folding joint of the sun visor. In contrast to the prior art, the desired switching of the transparency on or off can thus take place without complicated controlling means.

As an alternative, a switch may be provided for this purpose above the sun visor, for example simply on the roof lining, such that the visor presses against the switch and is switched off in the non-use position.

Both abovementioned switches can be realized in various ways. Firstly, as simple electric switches, for example, a toggle switch or sliding contact, which switch an electric signal on or off. The switches may also be designed as touch contacts transmitting merely a brief signal to a corresponding control unit. Alternatively, the switches may be designed as proximity sensors, acceleration sensors or in the form of a light barrier and then emit a corresponding switching signal.

According to one embodiment, the sun visor therefore includes a screening region which essentially covers the entire surface of the sun visor apart from a frame and which is transparent or opaque depending on the position.

The change in the transparency of the screening region of the sun visor can be achieved, for example, by the use of electrochromic material.

As an alternative, liquid crystal displays (LCD) or suspended particle device layers could also be used.

In a further embodiment, a mechanical movement of the sun visor can also change the light transmittance of the same. For this purpose, movement of the sun visor is transmitted via a suitable mechanism to a suitable mechanical light shutter in the sun visor. This may be, for example, a movable blind.

In another advantageous embodiment, the light transmittance of the sun visor changes by louvers in the sun visor being differently oriented. In the simplest case, these may be a plurality of louvers mounted rotatably and/or displaceably, in a similar manner as in a blind, the louvers being driven either mechanically via the movement of the sun visor or, for example, via an electric motor. The light transmittance can therefore likewise be set as required.

It is to be understood that variations and modifications can be made on the aforementioned structure without departing from the concepts of the present invention, and further it is to be understood that such concepts are intended to be covered by the following claims unless these claims by their language expressly state otherwise.

I claim:

1. A sun visor for a motor vehicle, which is configured so as to be foldable between a non-use position and a use position via a folding joint, wherein the sun visor is configured to be transparent in a non-use position and is opaque in the use position.

2. The sun visor as claimed in claim 1, wherein in the non-use position, the sun visor can be switched over between transparent and opaque.

3. The sun visor as claimed in claim 2 further comprising a switch provided in the folding joint of the sun visor.

4. The sun visor as claimed in claim 2 further comprises a switch provided above the sun visor.

5. The sun visor as claimed in claim 4, wherein the switch is provided in a roof lining

6. The sun visor as claimed in claim 1, wherein the sun visor comprises a screening region comprising a material which can change its light transmittance via a signal.

7. The sun visor as claimed in claim 6, wherein the signal is electric.

8. The sun visor as claimed in claim 6, wherein the screenable region contains electro chromatic material.

9. The sun visor as claimed in claim 6, wherein the screenable region has a liquid crystal display.

10. The sun visor as claimed in claim 1, wherein the screenable region has a suspended particle device layer.

11. The sun visor as claimed in claim 1, wherein a mechanical movement of the sun visor changes the light transmittance.

12. The sun visor as claimed in claim 1, wherein the light transmittance of the sun visor changes by louvers in the sun visor being differently oriented.

13. A sun visor for a motor vehicle, which is foldable between a non-use position and a use position via a folding joint, the sun visor comprising a screening region configured to be substantially transparent in a non-use position, and substantially opaque in a use position.
